(19) United States
(12) Patent Application Publication
(10) Pub. No.: US 2026/0184541 A1
(43) Pub. Date: Jul. 2, 2026

(54) METHOD AND DEVICE FOR MONITORING THE DRIVE OPERATION OF A PASSENGER CONVEYOR SYSTEM

(71) Applicant: INVENTIO AG, Hergiswil (CH)

(72) Inventors: Georg Wagenleitner, Roßleithen (AT); Adam Zhang, Shanghai (CN); Yixin Wu, Wien (AT); Bin Zhang, Shanghai (CN)

(21) Appl. No.: 18/837,040

(22) PCT Filed: Feb. 15, 2023
(86) PCT No.: PCT/EP2023/053771

§ 371 Date: Aug. 8, 2024

(30) Foreign Application Priority Data
Mar. 23, 2022 (EP) 22163704.4

(51) Int. Cl. B66B 25/00; B66B 27/00; B66B 29/00

(52) U.S. Cl. CPC B66B 25/003; B66B 25/006; B66B 27/00; B66B 29/00

(57) ABSTRACT

The disclosure relates to a monitoring system and to a method for monitoring passenger conveyor systems. The monitoring system has at least one hazard analysis module, an interaction module, a control module and at least one movement detection module, which are connected to one another via a data network. As soon as the hazard analysis module detects a critical situation in a movement sequence image of the movement detection module, the hazard analysis module sends a warning signal to the interaction module and the control module, wherein, directly after the warning signal is received, the movement sequence image correlating to the warning signal is reproduced on a screen of the interaction module and the control module initializes a change in the drive operation for the passenger conveyor system associated with the warning signal. Monitoring staff can suppress or cancel the change in the drive operation by actuating an input device.

### TECHNICAL FIELD

The present disclosure relates to a method for monitoring the drive operation of one or more passenger conveyor systems, and to a device for carrying out this method.

### SUMMARY

Passenger conveyor systems such as escalators and moving walkways are used, for example, in department stores and large shopping centers, but also in train stations, subway stations, and airports. In the three last-mentioned settings, there can be an increased risk of accidents during peak times if time-pressed users jostle other users on the passenger conveyor systems. This means that jostled persons can fall on the conveyor belt or stepped belt of the escalator or pallet belt of the moving walkway and sustain serious injuries if the stepped belt or pallet belt is not stopped by means of an emergency stop, for example. Others recklessly misuse passenger conveyor systems as sports and play equipment, putting themselves and other users in danger.

Video cameras are used to monitor these passenger conveyor systems, the video sequences from which are transmitted in real time to a monitoring room where they are displayed on screens. From the monitoring room, a plurality of passenger conveyor systems is usually monitored by monitoring staff, wherein a single monitoring operator is responsible for a group of passenger conveyor systems. In addition, the monitoring operator often monitors and operates the lighting, the fire alarm, the ventilation and, if necessary, other facilities such as security gates and the like in the region of their assigned group of passenger conveyor systems.

This high density of monitoring activities can lead to the monitoring operator becoming rapidly fatigued and paying less attention. If a critical situation occurs on one of the passenger conveyor systems, reduced attention can worsen the critical situation and, in severe cases, lead to serious injuries or, in the worst case, death of the affected user.

In order to solve the above problem, monitoring rooms are set up in such a way that critical situations for users on the passenger conveyor system can be automatically recognized by processing movement sequence images by means of image recognition. As soon as a critical situation is recognized, the corresponding movement sequence image is displayed on the monitoring room screen. The movement sequence image is provided with an identification number so that the monitoring operator can immediately identify on which passenger conveyor system in their group a critical situation has occurred.

Below the screen, a number of physical emergency-stop switches are arranged corresponding to the number of monitored passenger conveyor systems, wherein each emergency-stop switch is connected to the safety circuit of the corresponding passenger conveyor system. A corresponding monitoring system for a passenger conveyor system is disclosed, for example, in JP 5917327 B2.

As soon as a critical situation occurs, the monitoring staff must find the associated emergency-stop switch of the passenger conveyor system shown in the movement sequence image with its identification number and activate it.

This search can greatly reduce the emergency response speed and the monitoring staff in the monitoring room intervening too late. Additionally, in the case of dramatic scenes in the movement sequence image, the monitoring staff may panic and press the wrong emergency stop, resulting in an emergency stop of different passenger conveyor system that should not be stopping. This does not defuse the critical situation and causes inconvenience to the users of the mistakenly stopped passenger conveyor system, because a stopped system cannot be put back into operation immediately.

In the event of an abrupt stop, such as the emergency stop defined in standards (e.g., EN-115), users not affected by the critical situation may even fall and injure themselves. However, it is quite possible that a user who is falling can manage to break their fall again. This means that the critical situation resolves itself and an emergency stop is not necessary. In other words, situations may arise in which initiating an emergency stop does more harm than good to users. Such possible scenarios lead operators to believe that the expertise of monitoring staff cannot be dispensed with when assessing critical situations.

In order to solve the problems described above, the object of the present disclosure is to provide a monitoring system for a passenger conveyor system which minimizes the emergency response speed of the monitoring system, minimizes human error and takes into account the operators'beliefs.

This object can be achieved by a method for monitoring the drive operation of a passenger conveyor system with a monitoring system. The monitoring system can comprise a hazard analysis module, an interaction module, a control module, and at least one movement detection module. The movement detection module can be directed towards an associated passenger conveyor system and can capture electronically processable movement sequence images of situations that occur on the associated passenger conveyor system.

In other words, a movement detection module or a plurality of movement detection modules can be directed toward an associated passenger conveyor system and can continuously record the processes or situations currently occurring on the escalator or moving walkway. Video cameras, thermal imaging cameras, laser scanners, TOF cameras, a set of multiple sensors and the like can be used as movement detection modules, the movement sequence images of which can be accordingly captured as a video film sequence, image sequence, thermal image sequence, etc., in an electronically processable form. When a plurality of movement detection modules per passenger conveyor system are used, each movement detection module can be preferably associated with a specific section or region, so that the entire escalator or the entire moving walkway is not visible in any of the movement sequence images.

According to the present disclosure, the movement sequence images can be transmitted to the hazard analysis module in real time. In the hazard analysis module, the movement sequence images can be examined for critical situations using analysis algorithms. In other words, automated recognition processes or analysis methods known from the technical field of surveillance electronics, such as image analysis methods and corresponding algorithms, movement analysis methods and corresponding algorithms, statistical and heuristic evaluation methods and the like, can be used more for recognizing user movements that deviate from usual movements or are atypical movements. Depending on the movement sequence of a deviating movement process, the hazard analysis module can assume a critical situation. A possible embodiment of this automated assessment process is described in more detail herein.

As soon as a critical situation occurs in the movement sequence images and this situation is detected by the hazard analysis module, the hazard analysis module can generate a warning signal. The warning signal can be sent to the interaction module and the control module. Immediately after receiving the warning signal, the movement sequence image correlating with the warning signal can be displayed on a screen of the interaction module. On the basis of the warning signal, the control module can simultaneously initiate a change in the drive operation of the passenger conveyor system associated with the warning signal. The correlation between the warning signal and the correct movement sequence image can be achieved, for example, by the movement sequence image containing an identification number assigned by the movement detection module and the hazard analysis module also adding this identification number to the warning signal.

In other words, the monitoring system can automatically initiate the change in the drive operation of the passenger conveyor system on which a critical situation has been detected. This can result in an extremely safe and short reaction time, which cannot be achieved by the manual initiation described at the outset. This also eliminates human error.

However, a critical situation may resolve itself, for example, if a falling user is able to catch themselves. In such a scenario, an immediate stop of the drive operation would be unnecessary and could even affect other users. In order to be able to adequately react to such situations, the interaction module can comprise an input device that is also activated by the warning signal. By manual operation of the input device, the control module can be instructed to immediately suppress or cancel the change to the drive operation initiated by the warning signal.

In other words, the input device can enable the monitoring staff on duty to intervene in the automatic change to the drive operation of the passenger conveyor system and to suppress or cancel it. The input device can be a push button, a buzzer button, a virtually generated button on the screen (touch-sensitive screen surface) and the like.

As mentioned herein, an automated recognition process and assessment process of critical situations can take place in the hazard analysis module, wherein the deviating movement sequences recognized by known extraction and analysis methods can be extracted from the movement sequence images and then assessed. In order to carry out the assessment process, a set of possible critical situations can be stored in the hazard analysis module. This set can comprise various atypical movement scenarios that are compared with the movement sequences extracted from the movement sequence images.

This set of atypical movement scenarios can be generated, for example, through a machine learning process by using a dummy or stuntman to recreate and record typical critical situations such as falls or careless actions on the passenger conveyor system and to include the extracted movement sequences in the set as atypical movement scenarios. Of course, it is also possible to create such movement scenarios purely virtually with suitable software and sufficient computing power. Of course, the set can also be supplemented with further atypical movement scenarios which, during operation of the passenger conveyor system, had led to an accident and were not recognized by the hazard analysis module. Should an extracted movement sequence and an atypical movement scenario correspond sufficiently, the hazard analysis module may assume the existence of a critical situation and may send a warning signal to the interaction module and to the control module.

In one embodiment of the present disclosure, the various atypical movement scenarios in the set can have different weightings in the sense of a ranking. Different actions for changing the drive operation may be defined according to these weightings. For example, the control module can open a switch of a safety circuit of the passenger conveyor system, which immediately causes an emergency stop of the drive operation if the detected fall of a user has a very high weighting and an emergency stop is defined as the action for this high weighting.

It is also possible for a user to resolve the critical situation themselves, for example, by catching their fall by holding on to the handrail and then standing up again. However, the user may be required to still be in a semi-upright position. In the hazard analysis module, an atypical movement scenario corresponding to this posture can be given a medium weighting. In order to give the user sufficient time to “save” themselves, with medium weighting the control module may open a switch of a safety circuit of the passenger conveyor system after a predetermined delay time, causing an emergency stop of the drive operation after the delay time has elapsed. The monitoring operator may also have more time to decide whether or not to activate the input device.

If, for example, a user enters the passenger conveyor system in the opposite direction to its conveying direction, this critical situation can have a low weighting and, for this low weighting, the control module can send a brake signal to a controller of the passenger conveyor system, as a result of which brake signal braking of the drive operation of the passenger conveyor system can be carried out with its frequency inverter and its service brake. This braking can be done very gently so that users on the passenger conveyor system do not fall.

In a further embodiment of the present disclosure, after receiving a warning signal, the control module can issue warnings and/or instructions to the users of the passenger conveyor system associated with the warning signal. Warnings can be acoustic and/or visual warnings issued to the users of the passenger conveyor system via an output module. The output module can be arranged in the region of the passenger conveyor system which is associated with the warning signal. In other words, each passenger conveyor system can be associated with at least one output module which is operated on the basis of an identification number of the warning signal, for example. This can be preferably directed at the passenger conveyor system in such a way that the acoustic warning may address the users of this passenger conveyor system or individual users, and not the entire surrounding area. The output module can be a loudspeaker, a loudspeaker system, a screen display, a projector for two-dimensional representations or holograms and the like. A combination of acoustically and visually output warnings may be most effective. The warnings to be output can be tailored to the corresponding critical situation and its resolution, so that if an emergency stop is initiated, the other users are warned before it is initiated. Preferably, a set of different warnings is available, from which a warning adequate for the critical situation is automatically selected, for example, on the basis of the weighting described herein, and output via the output module.

In another embodiment of the present disclosure, the monitoring system can comprise a plurality of movement detection modules that capture movement sequence images from at least two different passenger conveyor systems. Each of the movement detection modules can comprise an identification number and may provide its movement sequence images with this identification number, or may encode its movement sequence images accordingly. As soon as the hazard analysis module has recognized a critical situation in a movement sequence image, it may provide the warning signal to be outputted with the same identification number that the corresponding movement sequence image with the critical situation has.

The hazard analysis module can also provide the warning signal issued with a passenger conveyor system identification number, which is uniquely assigned to the corresponding identification number of the movement detection module. This assignment can be made, for example, via an assignment table stored in the hazard analysis module. It is also possible for the assignment to be made in the control module if this is where the assignment table is stored. In this case, the warning signal may not need to contain a passenger conveyor system identification number.

In a further embodiment of the present disclosure and when weighting is implemented, the hazard analysis module can send warning signals with the associated weighting to the interaction module in immediate succession when a plurality of critical situations are identified simultaneously, wherein the movement sequence images are successively displayed on the screen of the interaction module on the basis of their weighting. In other words, the movement sequence image with the most critical situation may be emphasized first. Once a predetermined time has elapsed, the movement sequence image with the second most critical situation may be emphasized, and so on. A switch to the next movement sequence image can also occur if the monitoring staff has manually operated the input device.

As indicated herein, the input device can have a switch that is to be manually operated and is preferably activated as a result of a warning signal in order to avoid unintentional operation. However, it is much clearer for the monitoring staff if the interaction module generates a deletion input field on the screen for activating and manually operating the input device on the basis of the warning signal. By manually tapping the deletion input field, the interaction module can be prompted to cancel the warning signal and to withdraw the associated display of the corresponding movement sequence image. As explained in detail herein, when the input device is activated, the change in the drive operation automatically initiated by the warning signal can also be immediately suppressed or canceled.

In a further embodiment of the present disclosure, the interaction module can, upon receiving a warning signal, issue a visual and/or acoustic alarm to the monitoring staff in order to draw their attention to the movement sequence image displayed on the screen.

In a further embodiment of the present disclosure, the interaction module can comprise a plurality of small screens and one large screen. The number of screens can correspond to the number of movement detection modules, whereby, as a result of a warning signal, the movement sequence image corresponding to the warning signal is displayed on the large screen. This may visually emphasize the movement sequence image assigned a warning signal so that the responsible monitoring operator pays full attention thereto and can better recognize and assess details.

It is also possible that the hazard analysis module cannot recognize a critical situation because, for example, the movement sequence detected does not correspond to any of the atypical movement scenarios. To solve this problem, the monitoring system can be designed in such a way that each screen is touch-sensitive and when a small screen is tapped, its movement sequence image is displayed on the large screen. After a specified time, the interaction module can also send a warning signal with the corresponding identification number of the movement sequence image and the assigned passenger conveyor system identification number to the control module, which, on the basis of the warning signal received, can initiate a change in the drive operation of the passenger conveyor system associated with the warning signal.

Furthermore, the interaction module can also activate the input device of the monitoring system so that manual operation of the input device instructs the control module to immediately suppress or cancel the change in the drive operation initiated by the warning signal.

In other words, when looking through the various screens, a member of the monitoring staff may notice a situation that appears critical to them. By tapping the screen, the corresponding movement sequence image can be visually emphasized and easier to see. In addition, the change in the drive operation of the corresponding passenger conveyor system may already be prepared by tapping said screen. For example, this change can be defined as an emergency stop. In order to give the monitoring staff time to gain a more precise overview, a preset time can be set, after which the warning signal may be sent to the control module and the change in the drive operation or the emergency stop can be initiated immediately. If, upon closer inspection, the situation turns out not to be critical, the monitoring staff can operate the input device and delete the warning signal before it is sent to the control module or immediately suppress or cancel the change in the drive operation initiated by the warning signal.

In an alternative embodiment of the present disclosure, the interaction module can have a single, very large screen, which is divided into a plurality of small screen regions and one large screen region. The number of screen regions can correspond to the number of movement detection modules, whereby, as a result of a warning signal, the movement sequence image corresponding to the warning signal can be displayed in the large screen region. Otherwise, the functionality of this design is identical to the multi-screen design described above.

### BRIEF DESCRIPTION OF THE DRAWINGS

Embodiments of the present disclosure will be described herein with reference to the accompanying drawings, wherein neither the drawings nor the description are intended to be interpreted as limiting the present disclosure. Identical or equivalent features have the same reference signs. In the drawings:

FIG. 1: is a three-dimensional view of a passenger conveyor system, the drive operation of which is intended to be monitored, and of a monitoring system for monitoring this passenger conveyor system;

FIG. 2: is a three-dimensional view of a plurality of passenger conveyor systems, the drive operation of which is intended to be monitored, and of the monitoring system of FIG. 1 that has been adapted for monitoring a plurality of passenger conveyor systems.

### DETAILED DESCRIPTION

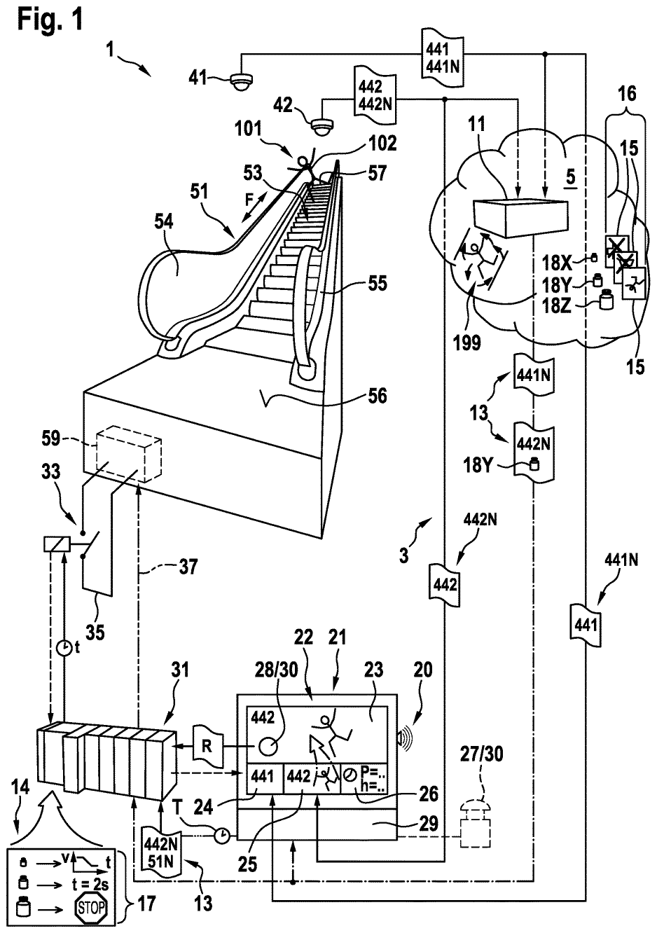

FIG. 1 shows a monitoring system 1 for a passenger conveyor system 51. The monitoring system 1 has a hazard analysis module 11, an interaction module 21, a control module 31, and two movement detection modules 41, 42. The aforementioned modules 11, 21, 31, 41, 42 are connected to one another via a data network 3. The design of the data network 3 is not shown in detail, since this can be set up in a variety of ways, such as via a local wired and/or wireless data network 3, via internet connections in a cloud 5, via CAN bus systems, Bluetooth connections, and the like. The fact that the individual modules 11, 21, 31, 41, 42 can exchange data with one another, it being possible for this data exchange between the individual modules 11, 21, 31, 41, 42 to take place unidirectionally or bidirectionally, as required, is relevant. The most important connections of the data network 3 are symbolically represented by means of arrows. It should also be mentioned that at least the hazard analysis module 11, optionally also a processing unit 29 of the interaction module 21 and/or the control module 31 and its data memory and processing units can be implemented in the data cloud 5.

The two movement detection modules 41, 42 are directed toward the associated passenger conveyor system 51. Of course, one movement detection module 41, 42 can also be present provided the conveying region 53 of the passenger conveyor system 51 is not too long and a single movement detection module 41, 42 is sufficient to oversee or record the entire conveying region 53 of the passenger conveyor system 51, the balustrades 54, 55 thereof and both access regions 56, 57 thereof.

The movement detection module 41, 42 can capture electronically processable movement sequence images 441, 442 of situations that occur on the associated passenger conveyor system 51. This can also include the immediate vicinity of the passenger conveyor system 51. The immediate vicinity can include, for example, the regions of the structure (not shown) upstream of the access regions 56, 57 in which the passenger conveyor system 51 is installed. The upstream regions of the structure are also referred to as entrances and may be monitored by proximity sensors of the passenger conveyor system 51, which proximity sensors transmit their sensory data to an “automatic start/stop system” of the passenger conveyor system 51.

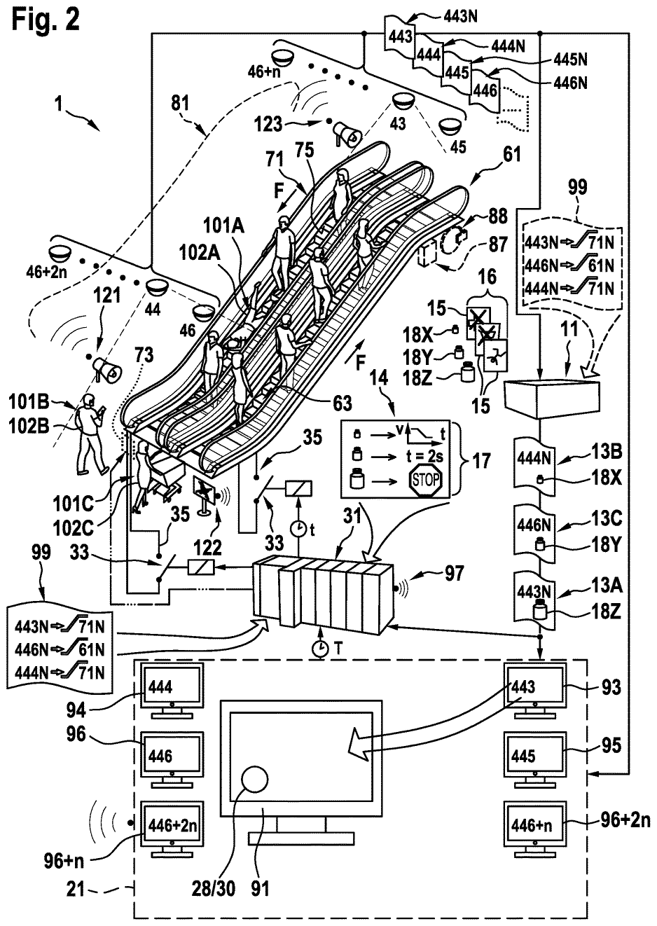

Video cameras, thermal imaging cameras, laser scanners, TOF cameras, a combination of multiple sensors and the like can be used as movement detection modules 41, 42, wherein the movement sequence images 441, 442 of which can be accordingly captured as a video film sequence, image sequence, thermal image sequence, etc., in an electronically processable form. When multiple movement detection modules 41, 42 are used in each passenger conveyor system 51, each movement detection module 41, 42 can be associated with a specific section or region (see FIG. 2). These regions preferably can overlap, so that there are no monitoring gaps in which critical situations 101 for users 102 can occur unobserved.

In order to efficiently and safely monitor the drive operation of the passenger conveyor system 51, the movement detection modules 41, 42 can transmit their movement sequence images 441, 442 in real time to the interaction module 21 and to the hazard analysis module 11 at the same time. For this purpose, the movement detection modules 41, 42 can provide their movement sequence images 441, 442 with their identification numbers 441N, 442N in order to be able to process them correctly in the hazard analysis module 11, interaction module 21 and the control module.

In the present example, the movement sequence images 441, 442 of the two movement detection modules 41, 42 are also displayed side by side on a screen 22 of the interaction module 21 so that a member (not shown) of the monitoring staff can see the entire drive operation F of the passenger conveyor system 51 in real time. In the present embodiment, the screen 22 is subdivided into a plurality of small screen regions 24, 25, 26 and one large screen region 23. There is an associated, small screen region 24, 25 for the movement sequence images 441, 442 of each movement detection module 41, 42. As shown in FIG. 1, an additional small screen region 26 is defined, on which, for example, operating data of the passenger conveyor system 51 under surveillance, ventilation, fire monitoring, and so forth can be displayed.

At the same time as the movement sequence images 441, 442 are displayed on the screen 22 of the interaction module 21, they can be examined for critical situations 101 for users 102 of the passenger conveyor system 51 in the hazard analysis module 11 with analysis algorithms. These analysis algorithms can be based, for example, on known image processing techniques that are optimized and applied in self-learning processes using artificial intelligence in neural networks. A common image processing technique for generating information from an image is, for example, the calculation of the histogram which provides information about the statistical brightness distribution in the image. Such a histogram can serve, for example, as a configuration for further image processing steps or as information for a human user of software. Other computable information about an image is, for example, its entropy or average brightness. On the basis of this information, vector analyses of image sequences can follow how individual prominent points move relative to one another and conclusions can be made therefrom about user movement scenarios 102. As soon as a movement sequence 199 (symbolically represented as a moving skeleton) of a user 102 has been extracted, for example as a skeleton movement sequence 199, and its movements have been detected, it can be compared with a stored set 16 of atypical movement scenarios 15 which represent possible critical situations 101. Of course, instead of the method described herein, other analysis techniques and analysis methods known from the technical field of video surveillance can also be used to extract movement sequences 199 of the user 102 from the movement sequence images 441, 442.

As the example shows, the movement detection module 42 arranged further back with respect to the viewing plane in FIG. 1 has recorded a movement sequence image 442 comprising a critical situation 101 and sent it to the hazard analysis module 11. There, the critical situation can be detected by extracting and comparing it and the hazard analysis module 11 sends a warning signal 13 to the interaction module 21 and to the control module 31 (dot-dash arrow). When the interaction module 21 receives this warning signal 13, the movement sequence image 442 associated with the warning signal 13 is displayed visually on the large screen region 23.

As mentioned herein, in the illustrated embodiment shown in FIG. 1, small screen regions 24, 25 can be defined according to the number of movement detection modules 41, 24, so that the movement sequence image 442 displayed on the large screen region 23 is also shown at the same time on the associated small screen region 25. Of course, the screen layout of the interaction module 21 can also be selected so that the number of small screen regions 24, 25, 26 is one region less than the number of movement detection modules 41, 42, so that the movement sequence image 441, 442 in which a critical situation was last recognized continues to run on the large screen region 23. As soon as a warning signal 13 is sent to the interaction module 21 again, the corresponding movement sequence image 441, 442 can swap “places” or screen regions with the movement sequence image 441, 442 displayed on the large screen region 23.

Since, as a result of the warning signal 13, the interaction module 21 can also show the movement sequence image 441, 442 displayed on a small screen region 24, 25, 26 on a larger screen region 23, it can be visually emphasized. Of course, this can, for example, additionally be emphasized by a red or yellow frame. In addition, the monitoring staff's attention can also be increased acoustically, for example, by defined beeps of an alarm 20. Other display layouts are also possible, for example, in the event of a warning signal 13, by zooming in on the corresponding small screen region 24, 25, 26 instead of a permanently present large screen region 23.

Since a critical situation 101 is usually a dynamic event, it is entirely possible that it is recorded first in the movement sequence image 442 of the movement detection module 42 arranged further back in relation to the viewing plane and then in the movement sequence image 441 of the movement detection module 41 arranged further forward. Since both movement sequence images 441, 442 can be simultaneously analyzed by the hazard analysis module 11, corresponding warning signals 13 can be transmitted one after the other to the interaction module 21 and control module 31, which can have the different identification numbers 441N, 442N of the movement sequence images 441, 442 assigned thereto. Logic can be implemented in a computing unit 29 of the interaction module 21, which logic automatically changes the movement sequence image 441, 442 displayed on the large screen region 23 according to the order of the warning signals 13.

Upon receipt of the warning signal 13, the control module 31 can initiate a change in the drive operation F of the passenger conveyor system 51 associated with the warning signal 13. This means that the control module 31 and the interaction module 21 can become active at the same time in response to an issued warning signal 13, whereby the control module 31 can initiate the change in the drive operation F and the interaction module 21 depicts or emphasizes the movement sequence image 441, 442 correlating with the warning signal 13 on its screen 22.

In other words, the change in the drive operation F of the passenger conveyor system 51, on which a critical situation 101 was detected, can be automatically initiated by the monitoring system 1. This may result in an extremely safe and short reaction time, which may not be achieved by pure video surveillance along with automated evaluation and manual initiation.

However, a critical situation 101 may resolve itself, for example, if a falling user 102 is able to break their fall. In such a scenario, an immediate emergency stop of the drive operation F could be unnecessary and could even affect other users. In order to be able to suitably react to such situations, the interaction module can have an input device 30, which can be also activated with the warning signal 13. By manually operating the input device 30, the control module 31 can be instructed, for example with a reset command R, to immediately suppress or cancel the change in the drive operation F initiated by the warning signal 13. In addition, manually tapping the input device 30 can prompt the interaction module 21 to delete the warning signal 13 and to withdraw the associated emphasized display of the corresponding movement sequence image 441, 442.

In other words, the input device 30 can enable the on-duty member of the monitoring staff to intervene in the automatic change in the drive operation F and to suppress or cancel it. The input device 30 can be a buzzer button 27 shown by a broken line, a virtually generated deletion input field 28 on the screen 22 (touch-sensitive screen surface), or the like.

It is also possible that the hazard analysis module 11 may not recognize a critical situation 101 because, for example, the recorded movement sequence does not correspond to any of the atypical movement scenarios 15 in the set 16. To solve this problem, the monitoring system 1 can be configured such that the screen 22 is touch-sensitive and when a small screen region 24, 25 is tapped, its movement sequence image 441, 442 is displayed on the large screen region 23. After a specified time T, the interaction module 21 can send a warning signal 13 with the corresponding identification number 441N, 442N of the movement sequence image 441, 442 and an associated passenger conveyor system identification number 51N to the control module 31, which, on the basis of the received warning signal 13, can initiate a change in the drive operation F of the passenger conveyor system 51 associated with the warning signal 13.

Furthermore, the interaction module 21 can also activate the input device 30 of the monitoring system 1 so that, by manually operating the input device 30, the control module 31 can be instructed to immediately suppress or cancel the change in the drive operation F initiated by the warning signal 13. If the input device 30 is operated manually or another small screen region 24, 25 is tapped before the specified time T has elapsed, no warning signal 13 may be sent to the control module 31. This correspondingly can also serve to prevent the change in the drive operation F initiated by the warning signal 13.

As mentioned herein, a set 16 of possible critical situations 101 can be stored in the hazard analysis module 11 as atypical movement scenarios 15, with which movement sequences 199 extracted from the movement sequence images 441, 442 can be compared. Should an extracted movement sequence 199 and an atypical movement scenario 15 correspond sufficiently, a critical situation 101 can be assumed to exist and the warning signal 13 can be sent to the interaction module 21 and the control module 31. Depending on the movement scenario 15 detected, different actions can be provided as to how the drive operation F of the passenger conveyor system 51 should be changed. For this purpose, an instruction set 14 comprising instructions 17 can be stored in the control module 31. The instructions 17 of the action to be executed may depend on the critical situation 101 detected and can be retrieved via a weighting 18X, 18Y, 18Z. For this purpose, each atypical movement scenario 15 can have its weighting 18X, 18Y, 18Z.

Accordingly, the warning signal 13 issued by the hazard analysis module 11 can also be provided with a weighting 18X, 18Y, 18Z.

FIG. 1 shows by way of example how a user 102 of the passenger conveyor system 51 stumbles and falls in its conveying region 53. The movement detection module 42 records this critical situation 101 in its movement sequence image 442 and sends it together with its identification number 442N to the interaction module 21, where it is displayed in the small screen region 25 provided for this purpose. At the same time, the same movement sequence image 442 is also sent to the hazard analysis module 11. The movement sequence 199 of the user 102 is extracted from the movement sequence image 442 with image processing methods and is compared with the set 16 of atypical movement scenarios 15 stored in the hazard analysis module 11. Since the extracted movement sequence 199 corresponds sufficiently to one of the atypical movement scenarios 15 that defines a stumble, the hazard analysis module 11 sends a warning signal 13 together with the medium weighting 18Y defined for stumbles to the interaction module 21 and to the control module 31. The sending of the warning signal 13 is shown by means of a dash-dotted arrow. The term “sufficient” here means assessing similarities within specified limits, which is defined, for example, by a percentage range of correspondence between the user's movement sequence and the movements stored in the atypical movement sequence pattern, which range of agreement is stored in the hazard analysis module.

When the warning signal 13 is sent, the movement sequence image 442 of the movement detection module 42 is also displayed in the large screen region 23 together with the deletion input field 28 of the input device 30.

In the control module 31, the instruction 17 assigned to the weighting 18X, 18Y, 18Z is retrieved and implemented. In the present example, an emergency stop is to be executed after a delay time of t=2 seconds with a medium weighting 18Y. The control module 31 opens a switch 33 of a safety circuit 35 of the passenger conveyor system 51 after the delay time t has elapsed, whereupon an emergency stop is immediately initiated by the controller 59 of the passenger conveyor system 51. If the monitoring staff taps the input device 30 during the delay time t, the control module 31 aborts the execution of the instruction 17 and does not open the switch 33. As shown by the arrow with a broken line, the safety circuit 35 reports that the switch 33 is open back to the control module 31 where it is then reported back to the interaction module 21 and displayed in the small screen region 26, for example.

The dash-and-double-dot arrow 37 shows that the control module 31 can also directly access the controller 59 of the passenger conveyor system 51 and transmit instructions 17 thereto to change the drive operation F. This is the case, for example, when a user 102 enters the passenger conveyor system 51 counter to the current conveying direction and a reduction in the conveying speed is provided as an instruction 17 for this atypical movement scenario 15.

FIG. 2 is a three-dimensional view of a plurality of passenger conveyor systems 61, 71, 81, the drive operation F of which is to be monitored. For this purpose, the monitoring system 1 in FIG. 1 has been adapted accordingly. This monitoring system 1 also has a hazard analysis module 11, an interaction module 21 and a control module 31.

In order to monitor a plurality of passenger conveyor systems 61, 71, 81, the monitoring system 1 additionally has a plurality of movement detection modules 43, 44, 45, 46, 46+n, 46+2n. In the present embodiment, two passenger conveyor systems 61, 71 designed as escalators are shown in detail. The balustrade outlined with a broken line symbolizes a plurality of additional passenger conveyor systems 81.

Each of these passenger conveyor systems 61, 71, 81 is associated with two movement detection modules 43, 44, 45, 46, 46+n, 46+2n, which capture movement sequence images 443, 444, 445, 446, . . . from the drive operation F of “their” passenger conveyor systems 61, 71, 81. Each of the movement detection modules 43, 44, 45, 46, 46+n, 46+2n has a code or an identification number 443N, 444N, 445N, 446N, . . . and encodes its movement sequence images 443, 444, 445, 446 accordingly.

As in the embodiment in FIG. 1, in the embodiment in FIG. 2 the movement sequence images 443, 444, 445, 446 . . . are also sent to the hazard analysis module 11 and to the interaction module 21 at the same time. In the event that a critical situation 101A, 101B, 101C is detected, the hazard analysis module 11 provides an output warning signal 13A, 13B, 13C with the corresponding identification number 443N, 444N, 445N, 446N, . . . of the movement sequence image 443, 444, 445, 446, . . . . Comprising the critical situation and sends this warning signal 13A, 13B, 13C to the interaction module 21 and to the control module 31, as symbolically indicated by the arrows.

Unlike in FIG. 1, the monitoring module 21 in FIG. 2 has a central screen 91 and additional screens 93 to 96+2n arranged in the immediate vicinity thereof, wherein there is an associated screen 93 to 96+2n for each movement detection module 43, 44, 45, 46, 46+n, 46+2n, which displays the movement sequence images 443, 444, 445, 446, . . . thereof in real time. When a warning signal 13A, 13B, 13C is received, the interaction module 21 displays, on the basis of the transmitted identification number 442N, 444N, 445N, 446N, . . . , the movement sequence image 443, 444, 445, 446, . . . associated with the warning signal 13A, 13B, 13C on the central screen 91. In order to visually emphasize the associated movement sequence image 443, 444, 445, 446, . . . , the central screen 91 has a larger screen area than the additional screens 93 to 96+2n.

As shown by a broken line, a unique assignment of passenger conveyor system identification numbers 61N, 71N, 81N to identification numbers 443N, . . . , 446N of the corresponding movement detection modules 43, . . . , 46+2n can be stored in the hazard analysis module 11 so that the control module 31 initiates the change in the drive operation F on the correct passenger conveyor system 61, 71, 81. Such an assignment can, for example, be stored as a table in a storage medium 99 of the hazard analysis module 11. In this case, the warning signal 13A, 13B, 13C may also have the corresponding passenger conveyor system identification number 61N, 71N, 81N. Alternatively, these assignments can also be stored in a storage medium 99 of the control module 31. In this case, it is not necessary for the warning signal 13A, 13B, 13C to have the corresponding passenger conveyor system identification number 61N, 71N, 81N.

Various critical situations 101A to 101C are also shown by way of example on the passenger conveyor systems 61, 71 shown in FIG. 2 and in the immediate vicinities thereof. A set 16 of possible critical situations is stored in the hazard analysis module 11 that matches these critical situations 101A, 101B, 101C. Specifically, the set 16 comprises various atypical movement scenarios 15 with which movement sequences 199 (see FIG. 1) extracted from the movement sequence images 443, 444, 445, 446, . . . are compared. The possible location at which such a critical situation 101A, 101B, 101C can take place may also play a role. An atypical movement scenario 15, which represents a fall in the inclined central section of an escalator, cannot occur in the same way in the entrance of the passenger conveyor system 61, 71, 81 or in one of the access regions 56, 57 (see FIG. 1). The set 16 of atypical movement scenarios 15 can be generated, for example, by a machine learning process by using a dummy or stuntman to recreate typical critical situations 101A, 101B, 101C such as falls or careless actions on the passenger conveyor system 61, 71, 81. The movement sequences 199 detected and extracted in this case can be included in the set 16 as atypical movement scenarios 15. Of course, the set 16 can also be supplemented with additional atypical movement scenarios 15 which, during operation of the passenger conveyor system 61, 71, 81, had led to an accident and which were not recognized by the hazard analysis module 11. In the event that an extracted movement sequence 199 and an atypical movement scenario 15 correspond sufficiently, the hazard analysis module 11 can assume or determine the existence of a critical situation 101A, 101B, 101C and send a warning signal 13A, 13B, 13C to the interaction module 21 and the control module 31.

As symbolically represented by weights of different sizes, the various atypical movement scenarios 15 of the set 16 can have different weightings 18X, 18Y, 18Z in the sense of a ranking. The critical situation 101A recorded by the movement detection module 43 is recognized in the hazard analysis module 11 as a “fall” and the associated warning signal 13A is provided with the highest weighting 18Z, since continued drive operation F could lead to serious injuries to the user 102A who has fallen.

The critical situation 101B recorded by the movement detection module 44 is recognized in the hazard analysis module 11 as “entering in the wrong direction” and the associated warning signal 13B is provided with the lowest weighting 18X. By entering incorrectly, the user 102B is not putting themselves in immediate danger, but rather disturbs the oncoming users leaving the passenger conveyor system 71.

The critical situation 101C recorded by the movement detection module 46 is recognized in the hazard analysis module 11 as “entering with a shopping cart” and the associated warning signal 13C is provided with a medium weighting 18Y. The user 102C can be in danger when they reach the ascending central part of the passenger conveyor system 61 with their shopping cart.

As in the embodiment of FIG. 1, in FIG. 2 an instruction set 14 comprising instructions 17 can also be stored in a storage medium (not shown) of the control module 31. The instructions 17 can be retrieved according to the weighting 18X, 18Y, 18Z of the warning signal 13A, 13B, 13C and implemented by the control module 31. When the deletion input field 28 of the input device 30 is tapped, the control module 31 can be instructed to suppress or cancel the change in the drive operation For the implementation of the retrieved instruction 17.

It should be mentioned at this point that the suppression or cancelation of the retrieved instruction 17 to change the drive operation F may depend on the type of instruction 17 and its implementation progress at the time when the input device 30 was manually actuated. For example, the instruction 17 “Emergency stop” may not be suppressed or canceled once a switch 33 of a safety circuit 35 has been opened by the control module 31. As long as the switch 33 is closed, abortion (prevention) is still possible; otherwise, the emergency stop may be carried out until the drive operation F comes to a complete standstill. However, the instruction 17 “Slow down using frequency inverter 87 and brake 88” can also be suppressed or canceled by the input device 30 after its implementation has been started, for example, by maintaining the travel speed of the relevant passenger conveyor system 61, 71, 81 from the time the input device 30 is manually actuated (suppressing) or by increasing it back to the nominal speed according to a predetermined acceleration profile (canceling). The termination criteria for suppression or cancelation above by way of example and the associated control processes are preferably also part of the instructions 17.

In other words, when the deletion input field 28 is tapped, the control module 31 can specifically be instructed to immediately suppress or cancel the change in the drive operation F. Whether this “deletion command” is implemented, partially implemented or not implemented may depend on the logic stored in the control module 31, which takes into account the current operating parameters of the passenger conveyor system 61, 71, 81 as well as the termination criteria of the instructions 17.

In the critical situation 101A detected by the movement detection module 43, an instruction 17 is retrieved due to the high weighting 18Z, in which the control module 31 immediately controls a safety switch 33 of the relevant passenger conveyor system 71 and initiates an emergency stop.

In the critical situation 101C detected by the movement detection module 46, an instruction 17 is retrieved due to the medium weighting 18Y, in which the control module 31 controls a safety switch 33 of the relevant passenger conveyor system 61 with a predefined delay time t. This provides sufficient time to warn the user 102C (see below) so that he/she leaves the entrance of the passenger conveyor system 61 before he/she reaches its conveying region 63 and a stop is initiated.

In the critical situation 101B detected by the movement detection module 44, an instruction 17 is retrieved which is sent from the control module 31 to a controller 73 of the relevant passenger conveyor system 71, as shown symbolically by a dash-and-triple-dot arrow. This instruction 17 causes the controller 73 to reduce the travel speed of a conveyor belt 75 of the relevant passenger conveyor system 71 according to a predetermined deceleration profile.

It goes without saying that, if two critical situations 101A, 101B occur at the same time on the same passenger conveyor system 71 and warning signals 13A, 13B are forwarded to the control module 31 in quick succession, the instruction 17 with the higher weighting 18Z is preferably implemented by the control module 31.

Since a plurality of passenger conveyor systems 61, 71, 81 are monitored with the monitoring system 1 in FIG. 2, it is entirely possible for a plurality of critical situations 101A, 101B, 101C to occur simultaneously, as shown. In this situation, the hazard analysis module 11 sends warning signals 13A, 13B, 13C with the associated weightings 18X, 18Y, 18Z to the interaction module 21 and the control module 31 in immediate succession. The movement sequence images 443, 444, 445, 446, . . . are now visually and/or acoustically emphasized on the central screen 91 in the interaction module 21 based on their weighting 18X, 18Y, 18Z, so that the monitoring staff can always assess the most critical situations 101A, 101B, 101C first.

This “succession” can be implemented in different ways. This allows the corresponding movement sequence image 443, 444, 445, 446, . . . to be emphasized for a prespecified period of time before the next movement sequence image 443, 444, 445, 446, . . . is displayed. The change to the next movement sequence image 443, 444, 445, 446, . . . can also be made by tapping the deletion input field 28.

In the present embodiment in FIG. 2, the interaction module 21 generates a deletion input field 28 of the input device 30 on the screen 91 as a result of the warning signal 13A, 13B, 13C. By manually tapping the deletion input field 28, the interaction module 21 can be prompted to cancel the warning signal 13A, 13B, 13C and withdraw the associated visual and/or acoustic emphasis of the corresponding movement sequence image 443, 444, 445, 446, . . . or no longer display it on the central screen 91. At the same time, the control module 31 can be instructed to immediately suppress or cancel the change in the drive operation F that is assigned to the deleted warning signal 13A, 13B, 13C and has already been initialized.

In order to warn the users 102A, 102B, 102C of an imminent change in the drive operation F and/or to draw attention to any incorrect behavior, if a warning signal 13A, 13B, 13C is provided, the control module 31 outputs an acoustic and/or visual warning to the users 102A, 102B, 102C of the passenger conveyor system 61, 71, 81 via an output module 121, 122, 123. The output module 121, 122, 123 is arranged in the region of the passenger conveyor systems 61, 71, 81. The control module 31 preferably controls the output modules 121, 122, 123 which belong to the passenger conveyor system 61, 71, 81 that is associated with the warning signal 13A, 13B, 13C. The visual and/or acoustic warning contains a message correlating with the critical situation 101A, 101B, 101C. This is described in more detail below on the basis of the critical situations 101A, 101B, 101C shown in FIG. 2.

In the case of the critical situation 101A, a “fall” was recognized by the hazard analysis module 11 and a corresponding warning signal 13A was generated. Its identification number 443N causes the control module 31 to select the output module 123 closest to the movement detection module 43. For example, the acoustic warning “Attention: emergency stop of the escalator” selected based on the weighting 18Z is sent to this output module 123, which is designed as a loudspeaker, via a wireless connection 97.

In the case of the critical situation 101B, an “access in the wrong direction” was recognized by the hazard analysis module 11 and a corresponding warning signal 13B was generated. Its identification number 444N causes the control module 31 to select the output module 121 closest to the movement detection module 44. For example, the acoustic warning “Attention: wrong access region” selected based on the weighting 18X is sent to this output module 123, which is designed as a loudspeaker, via a wireless connection 97.

In the case of the critical situation 101C, a “prohibited entry with shopping cart” was recognized by the hazard analysis module 11 and a corresponding warning signal 13C was generated. Its identification number 446N causes the control module 31 to select the output module 122 closest to the movement detection module 46. For example, an image with a crossed-out shopping cart is sent to this output module 122, which is designed as a screen, as a visual warning via a wireless connection 97 and displayed on the screen. Of course, a warning sound can also be output in this case so that the output module attracts more attention. In principle, any device that can output an acoustic and/or visual warning can be used as output modules 121, 122, 123. So-called hologram projectors, with which, for example, virtual persons can output acoustic warnings and hand gestures to the users 102A, 102B, 102C of the passenger conveyor systems 61, 71, 81, are particularly effective here.

Although FIGS. 1 and 2 show different variants of the monitoring system 1, it is obvious that they can be combined with one another. For example, the arrangement of a plurality of screens 91, 93, 94, 95, 96 shown in FIG. 2 can also be implemented in a monitoring system 1 of FIG. 1, and vice versa. Furthermore, the “automatic change” described in connection with FIG. 1 of the movement sequence image 441, 442 shown in the large screen region 23 can also be implemented in a monitoring system 1 according to FIG. 2 if the same critical situation 101, 101A, 101B, 101C is detected by a plurality of movement detection modules 41, . . . , 46+2n during the time sequence thereof. Of course, the described weightings 18X, 18Y, 18Z are not limited to three weightings; each atypical movement scenario 15 can have its own permanently assigned weighting 18X, 18Y, 18Z. The same applies to the instruction set 14 comprising instructions 17, whereby for each atypical movement scenario 15 or each known critical situation 101A, 101B, 101C there can be an instruction 17 specifically tailored thereto.

Finally, it should be noted that terms such as “having,” “comprising,” etc., do not preclude other elements or steps, and terms such as “a” or “one” do not preclude a plurality. Reference signs in the claims should not be considered to be limiting.

1-15. (canceled)

16. A method for monitoring a drive operation of a passenger conveyor system with a monitoring system, wherein the monitoring system comprises a hazard analysis module, an interaction module, a control module and at least one movement detection module, wherein the at least one movement detection module is directed toward an associated passenger conveyor system and is configured to record electronically processable movement sequence images of situations that occur on the associated passenger conveyor system, the method comprising:
transmitting the electronically processable movement sequence images in real time to the hazard analysis module and performing an analysis therein as to whether there is a critical situation for users of the passenger conveyor system in the electronically processable movement sequence images;
generating, with the hazard analysis module, a warning signal when a critical situation occurs in the electronically processable movement sequence images;
sending the warning signal to the interaction module and the control module and displaying on a screen of the interaction module the electronically processable movement sequence image correlating with the warning signal after receipt of the warning signal;
initiating, with the control module, a change in the drive operation of the passenger conveyor system associated with the warning signal;
activating, with the interaction module, an input device of the monitoring system; and
instructing the control module to suppress or cancel the change in the drive operation initiated by the warning signal upon manual operation of the input device.

17. The method of claim 16, wherein a set of possible critical situations is stored in the hazard analysis module, wherein the set comprises various atypical movement scenarios with which movement sequences extracted from the electronically processable movement sequence images are compared, and if an extracted movement sequence and an atypical movement scenario correspond sufficiently, an existence of a critical situation is assumed and the warning signal is sent to the interaction module and the control module.

18. The method of claim 17, wherein the various atypical movement scenarios in the set have different weightings in the sense of a ranking.

19. The method of claim 18, wherein the drive operation is changed on the basis of the weighting so that, according to the weighting,
the control module opens a switch of a safety circuit of the passenger conveyor system, which causes an emergency stop of the drive operation; or
the control module opens a switch of a safety circuit of the passenger conveyor system after a predetermined delay time, whereby an emergency stop of the drive operation takes place after the predetermined delay time has elapsed; or
the control module sends a braking signal to a controller of the passenger conveyor system, with which braking signal the drive operation of the passenger conveyor system is braked with its frequency inverter and its service brake.

20. The method according of claim 16, wherein upon receipt of the warning signal, the control module issues at least one of warnings or instructions to the users of the passenger conveyor system associated with the warning signal.

21. The method of claim 20, wherein the control module outputs at least one of an acoustic or a visual warning to the users of the passenger conveyor system via an output module, and wherein the output module is arranged in a region of the passenger conveyor system with which the warning signal is associated.

22. The method of claim 18, wherein the monitoring system comprises a plurality of movement detection modules configured to record movement sequence images of at least two different passenger conveyor systems, wherein each movement detection module of the plurality of movement detection modules comprises an identification number and provides its movement sequence images with said identification number and the hazard analysis module provides the warning signal with the identification number, wherein a unique assignment of passenger conveyor system identification numbers to the identification number of each movement detection module of the plurality of movement detection modules is stored in the hazard analysis module or the control module so that the control module initiates the change in the drive operation on the passenger conveyor system with the passenger conveyor system identification number correlated to the identification number of the plurality of movement detection modules that transmitted the warning signal in the unique assignment.

23. The method of claim 18, wherein the hazard analysis module sends warning signals with the weighting to the interaction module in succession when a plurality of critical situations are detected simultaneously, wherein the electronically processable movement sequence images are displayed and emphasized successively on the screen on the basis of their weighting.

24. The method of claim 16, wherein, on the basis of the warning signal, the interaction module generates a deletion input field on the screen for activating and manually operating the input device, and, by manually tapping the deletion input field, the interaction module is prompted to cancel the warning signal and to withdraw the display of the electronically processable movement sequence image.

25. The method of claim 16, wherein, upon receipt of the warning signal, the interaction module issues at least one of a visual or an acoustic alarm to monitoring staff who are responsible for the manual operation of the input device.

26. The method of claim 16, wherein the interaction module comprises a plurality of small screens and one large screen and a number of screens corresponds to a number of movement detection modules, wherein, as a result of the warning signal, the electronically processable movement sequence image corresponding to the warning signal is displayed on the one large screen.

27. The method of claim 26, wherein each screen is touch-sensitive and, when a small screen of the plurality of small screens is tapped, the electronically processable movement sequence image thereof is reproduced on the one large screen, and wherein, after a fixed predefined time, the interaction module sends the warning signal together with an identification number and a passenger conveyor system identification number to the control module, and the input device of the monitoring system is activated.

28. The method of claim 16, wherein the screen of the interaction module is divided into a plurality of small screen regions and one large screen region and a number of screen regions corresponds to a number of movement detection modules, wherein, as a result of the warning signal, the electronically processable movement sequence image corresponding to the warning signal is displayed in the one large screen region.

29. The method of claim 28, wherein the screen is touch-sensitive and, when a small screen region of the plurality of small screen regions is tapped, the electronically processable movement sequence image thereof is reproduced in the one large screen region, and wherein, after a fixed predefined time, the interaction module sends the warning signal together with an identification number and a passenger conveyor system identification number to the control module, and the input device of the monitoring system is activated.

30. A monitoring system for carrying out the method of claim 16, wherein the monitoring system comprises at least one hazard analysis module, the interaction module, the control module and the at least one movement detection module, which are connected to one another via a data network, wherein the interaction module comprises the input device which, after being manually operated, is configured to suppress or cancel a change in the drive operation initiated by the monitoring system.

31. The method according of claim 17, wherein upon receipt of the warning signal, the control module issues at least one of warnings or instructions to the users of the passenger conveyor system associated with the warning signal.

32. The method of claim 19, wherein the monitoring system comprises a plurality of movement detection modules configured to record movement sequence images of at least two different passenger conveyor systems, wherein each movement detection module of the plurality of movement detection modules comprises an identification number and provides its movement sequence images with said identification number and the hazard analysis module provides the warning signal with the identification number, wherein a unique assignment of passenger conveyor system identification numbers to the identification number of each movement detection module of the plurality of movement detection modules is stored in the hazard analysis module or the control module so that the control module initiates the change in the drive operation on the passenger conveyor system with the passenger conveyor system identification number correlated to the identification number of the plurality of movement detection modules that transmitted the warning signal in the unique assignment.

33. The method of claim 19, wherein the hazard analysis module sends warning signals with the weighting to the interaction module in succession when a plurality of critical situations are detected simultaneously, wherein the electronically processable movement sequence images are displayed and emphasized successively on the screen on the basis of their weighting.

34. The method of claim 17, wherein, on the basis of the warning signal, the interaction module generates a deletion input field on the screen for activating and manually operating the input device, and, by manually tapping the deletion input field, the interaction module is prompted to cancel the warning signal and to withdraw the display of the electronically processable movement sequence image.

35. The method of claim 17, wherein, upon receipt of the warning signal, the interaction module issues at least one of a visual or an acoustic alarm to monitoring staff who are responsible for the manual operation of the input device.
